(19) United States
(12) Patent Application Publication
(10) Pub. No.: US 2018/0149912 A1
(43) Pub. Date: May 31, 2018

(54) DISPLAY PANEL, METHOD OF MANUFACTURING DISPLAY PANEL, AND DISPLAY APPARATUS

(71) Applicants: BOE Technology Group Co., Ltd., Beijing (CN); Beijing BOE Display Technology Co., Ltd., Beijing (CN)

(72) Inventors: Zhenyu Zhang, Beijing (CN); Fangyu Wang, Beijing (CN); Chunguang Tian, Beijing (CN); Yanping Liao, Beijing (CN); Weihao Hu, Beijing (CN)

(21) Appl. No.: 15/576,098

(22) PCT Filed: Apr. 25, 2017
(86) PCT No.: PCT/CN2017/081859

§ 371 Date: Nov. 21, 2017

(30) Foreign Application Priority Data
Apr. 28, 2016 (CN) 201610280526.9

(51) Int. Cl. G02F 1/1335; G02F 1/1362; G02F 1/1343

(52) U.S. Cl. CPC G02F 1/133512; G02F 1/1343; G02F 1/133514; G02F 1/136286

(57) ABSTRACT

Embodiments of the present disclosure provide a display panel, a method of manufacturing the display panel, and a display apparatus. The display panel includes a plurality of pixel units arranged in a matrix and each including a first sub-pixel, a second sub-pixel and a third sub-pixel arranged in an arrangement direction. The first sub-pixels of ones, adjacent to one another in the arrangement direction, of the plurality of pixel units are adjacent to one another, and no black matrix is disposed at a corresponding position between the adjacent first sub-pixels.

### CROSS-REFERENCE TO RELATED APPLICATIONS

This application is a Section 371 National Stage Application of International Application No. PCT/CN2017/081859, filed on 25 Apr. 2017, entitled “DISPLAY PANEL, METHOD OF MANUFACTURING DISPLAY PANEL, AND DISPLAY APPARATUS”, which has not yet published, which claims priority to Chinese Application No. 201610280526.9, filed on 28 Apr. 2016, incorporated herein by reference in their entirety.

### BACKGROUND

### 1. Technical Field

Embodiments of the present disclosure relate to a display panel, a method of manufacturing the display panel, and a display apparatus.

### 2. Description of the Related Art

As shown in FIG. 1, a display panel 100 of a display generally comprises sub-pixels 10 arranged in a matrix, and a light-intransmissible black matrix 11 is disposed between two adjacent different ones of the sub-pixels 10 to prevent color crosstalk from occurring between the two adjacent different sub-pixels 10. The sub-pixels 10 of different colors can transmit white light emitted by a backlight source of the display, thereby displaying a picture of different colors. However, the black matrix 11 is light-intransmissible, and has a certain light blocking effect. Therefore, light cannot be transmitted at a position corresponding to the black matrix 11, so that an aperture ratio of the entire display panel is decreased.

### SUMMARY

On one hand, embodiments of the present disclosure provide a display panel comprising: a plurality of pixel units arranged in a matrix, and each comprising a first sub-pixel, a second sub-pixel, and a third sub-pixel arranged in an arrangement direction. The first sub-pixels of ones, adjacent to one another in the arrangement direction, of the plurality of pixel units are adjacent to one another, and no black matrix is disposed at a corresponding position between the adjacent first sub-pixels.

According to embodiments of the present disclosure, the third sub-pixels of ones, adjacent to one another in the arrangement direction, of the plurality of pixel units are adjacent to one another, and no black matrix is disposed at a corresponding position between the adjacent third sub-pixels.

According to embodiments of the present disclosure, the display panel further comprises: a black matrix, and an array substrate assembly, wherein the array substrate assembly comprises a plurality of data lines, and the black matrix is disposed at a position corresponding to the data lines, wherein the data lines are not disposed at the corresponding position between the adjacent first sub-pixels.

According to embodiments of the present disclosure, the display panel further comprises: a black matrix, and an array substrate assembly, wherein the array substrate assembly comprises a plurality of data lines, and the black matrix is disposed at a position corresponding to the data lines, wherein the data line for each of the adjacent first sub-pixels of the adjacent pixel units is disposed at a corresponding position between the each first sub-pixel of the corresponding pixel unit and another sub-pixel adjacent to the each first sub-pixel.

According to embodiments of the present disclosure, the first sub-pixel is a red sub-pixel, the second sub-pixel is a green sub-pixel, and the third sub-pixel is a blue sub-pixel.

According to embodiments of the present disclosure, the display panel further comprises: a color filter layer comprising color filter units, wherein the color filter units of the adjacent first sub-pixels are disposed in an integrated structure.

According to embodiments of the present disclosure, the display panel further comprises: a color filter layer comprising color filter units; and a transparent region located between the color filter units of the adjacent first sub-pixels and connected directly to the color filter units of the adjacent first sub-pixels.

According to embodiments of the present disclosure, a first planar electrode and a second electrode composed of a plurality of strip-shaped sub-electrodes are disposed in each sub-pixel in the array substrate assembly.

According to embodiments of the present disclosure, the first electrode is a common electrode, and the second electrode is a pixel electrode, and the common electrodes of the adjacent first sub-pixels are disposed in an integrated structure.

According to embodiments of the present disclosure, the first electrode is a pixel electrode, and the second electrode is a common electrode.

According to embodiments of the present disclosure, a spacing between the pixel electrodes of the adjacent first sub-pixels is in the range of 4.5 μm-5.5 μm.

Embodiments of the present disclosure also provide a display apparatus comprising the above-mentioned display panel.

Embodiments of the present disclosure further provide a method of manufacturing a display panel, comprising: forming a plurality of pixel units, arranged in a matrix, on a substrate, wherein each of the plurality of pixel units comprises a first sub-pixel, a second sub-pixel, and a third sub-pixel arranged in an arrangement direction, the first sub-pixels of ones, adjacent to one another in the arrangement direction, of the plurality of pixel units are adjacent to one another, and no black matrix is disposed at a corresponding position between the adjacent first sub-pixels.

The embodiments of the present disclosure provide a display panel, a method of manufacturing the display panel, and a display apparatus. The display panel further comprises a plurality of pixel units arranged in a matrix and each comprising a first sub-pixel, a second sub-pixel and a third sub-pixel arranged in an arrangement direction, the first sub-pixels of ones, adjacent to one another in the arrangement direction, of the plurality of pixel units are adjacent to one another, and no black matrix is disposed at a corresponding position between the adjacent first sub-pixels.

### BRIEF DESCRIPTION OF THE DRAWINGS

In order to describe embodiments of the present disclosure or technical solutions in the prior art more clearly, accompanying drawings required for describing the embodiments or the prior art will be simply explained as below. Apparently, the accompanying drawings for the following description are only some embodiments of the present disclosure. Those skilled in the art also could derive other accompanying drawings from these accompanying drawings without making a creative work.

FIG. 1 is a schematic diagram showing a configuration of a conventional display panel;

FIG. 2 is a schematic diagram showing a configuration, including a sub-pixel sequence, of a display panel according to an embodiment of the present disclosure;

FIG. 3 is a schematic diagram showing a configuration of a twist nematic (TN) type display panel according to an embodiment of the present disclosure;

FIG. 4 is a schematic diagram showing a configuration of a display panel according to an embodiment of the present disclosure;

FIG. 5 is a schematic diagram showing an arrangement of data lines of a display panel according to an embodiment of the present disclosure;

FIG. 6 is a schematic diagram showing a configuration of another display panel, including a color-filter-on-array (COA) type array substrate assembly, according to an embodiment of the present disclosure;

FIG. 7 is a schematic diagram showing a configuration of a display panel, including the COA type array substrate assembly, according to an embodiment of the present disclosure;

FIG. 8 is a schematic diagram showing a configuration of an advanced super dimensional switching (ADS) type display panel according to an embodiment of the present disclosure;

FIG. 9 is a schematic diagram showing a configuration of an ADS type display panel according to an embodiment of the present disclosure; and

FIG. 10 is a schematic diagram showing an arrangement of liquid crystal molecules between two adjacent same pixel units in FIG. 9.

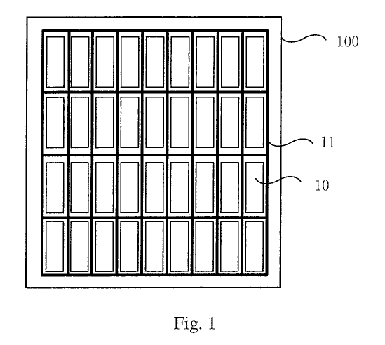

### DETAILED DESCRIPTION OF THE EMBODIMENTS

A clear and complete description of technical solutions in embodiments of the present disclosure will be made as below in conjunction with the accompanying drawings in the embodiments of the present disclosure. Apparently, the described embodiments are only some of the embodiments of the present disclosure rather than all of the embodiments of the present disclosure. All other embodiments derived by those skilled in the art based on the embodiments of the present disclosure without making a creative work shall fall within the protection scope of the present disclosure.

Embodiments of the present disclosure provide a display panel. As shown in FIG. 2, the display panel 100 comprises a plurality of pixel units 101 arranged in a matrix, and each of the pixel units 101 comprises a first sub-pixel 1011, a second sub-pixel 1012 and a third sub-pixel 1013 arranged in an arrangement direction X of sub-pixels 10. Further, the first sub-pixels 1011 of ones, adjacent to one another in the arrangement direction X of the sub-pixels 10, of the plurality of pixel units 101 are adjacent to one another, and no black matrix 11 is disposed at a corresponding position between the adjacent first sub-pixels 1011.

Since each of the pixel units comprises the first sub-pixel, the second sub-pixel and the third sub-pixel, and the first sub-pixels of the adjacent pixel units are adjacent to one another, two sub-pixels respectively located in two adjacent pixel units and having the same color can adjoin each other. Since there is no color crosstalk between two sub-pixels adjoining each other and having the same color, no black matrix may be disposed at a corresponding position between the two sub-pixels adjoining each other and having the same color. In this way, an area of a light-transmissible portion of the display panel and thus an area of an effective display region of the display panel can be increased, thereby raising an aperture ratio of the display panel.

In addition, the third sub-pixels 1013 of ones, adjacent to one another in the arrangement direction X, of the plurality of pixel units 101 are adjacent to one another, and no black matrix 11 is disposed at a corresponding position between the adjacent third sub-pixels 1013. As a result, no black matrix 11 is disposed between the adjacent first sub-pixels 1011 and between the adjacent third sub-pixels 1013, so that an area of a light-transmissible portion of the display panel is further increased, thereby raising an aperture ratio of the display panel.

It should be noted that the sub-pixels 10 forming the pixel units 101 are bounded by a plurality of gate lines (G1, G2 . . . Gm) and a plurality of data lines (D1, D2 . . . Dn) respectively extending in a vertical direction and a horizontal direction and crossing each other, and the black matrix 11 is disposed at a position corresponding to the gate lines (G1, G2 . . . Gm) and the data lines (D1, D2 . . . Dn) as shown in FIG. 2, where m and n are positive integers greater than or equal to 1, as shown in FIG. 5. In this case, the arrangement direction X of the sub-pixels 10 in the embodiments of the present disclosure is a direction parallel to the gate lines.

In addition, “no black matrix 11 is disposed at a corresponding position between the adjacent first sub-pixels 1011” may mean that the black matrix 11 between the adjacent first sub-pixels 1011 is directly removed so that light can be transmitted between the adjacent first sub-pixels 1011, and thus a transparent region is formed between the adjacent first sub-pixels 1011, thereby increasing an area of a light-transmissible portion of the display panel 100.

Or, after the black matrix 11 between the adjacent first sub-pixels 1011 is removed, color filter areas of the adjacent same sub-pixels 10 may also be added so that the added color filter areas of the sub-pixels 10 covers the position where the black matrix 11 is otherwise disposed. In this way, an amount of transmitted part of white light from a backlight source can be decreased compared with the solution in which the black matrix 11 is directly removed, so that a contrast of a picture displayed by the display panel 100 can be raised while the area of the light-transmissible portion of the display panel 100 is increased.

In addition, an arrangement manner in which no black matrix 11 is disposed at a corresponding position between the third sub-pixels 1013 adjacent in the arrangement direction is the same as that in which no black matrix 11 is disposed at a corresponding position between the adjacent first sub-pixels 1011, and is no longer described herein for the sake of brevity.

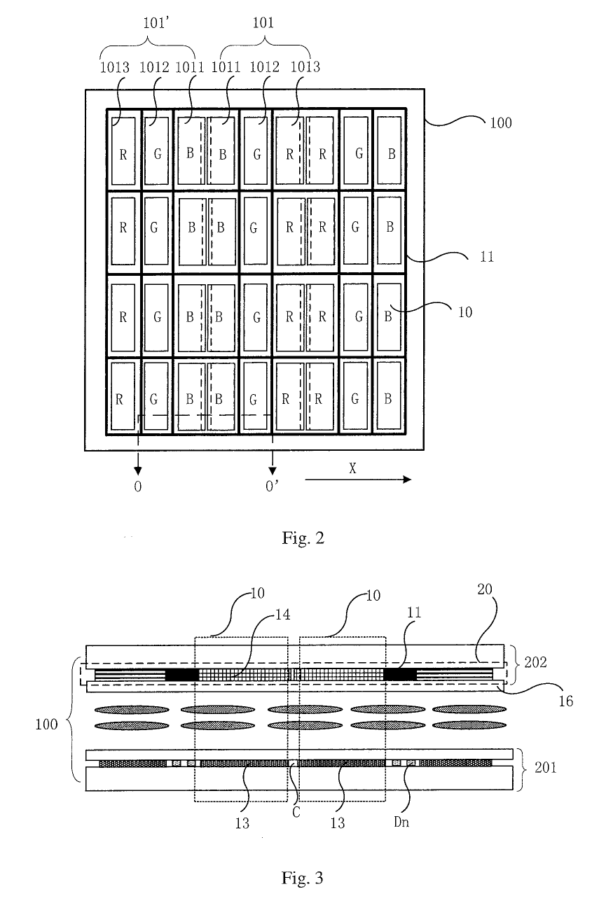

In addition, as shown in FIG. 3, when the display panel 100 comprises a color filter layer 20 comprising color filter units 14, a transparent region may be formed between the color filter units 14 to directly adjoin the color filter units, or areas of the color filter units 14 of the two adjacent same sub-pixels 10 may be increased, thereby increasing color filter areas of the two adjacent same sub-pixels 10.

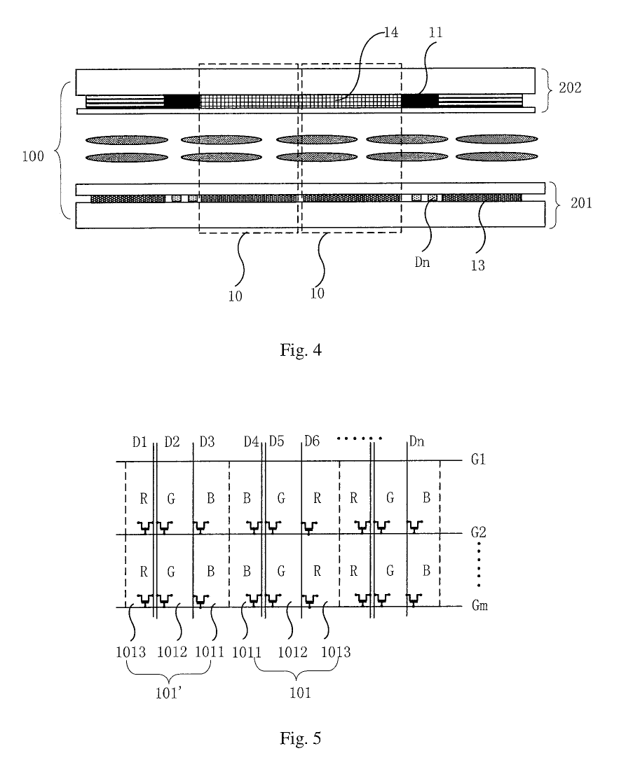

In addition, in order to further raise a contrast of a picture displayed by the display panel 100, as shown in FIG. 4, the color filter units 14 of the two adjacent same sub-pixels 10 may be disposed in an integrated structure, so that no gap is formed between the color filter units 14 of the two adjacent same sub-pixels 10, avoiding a problem that the contrast is decreased because a backlight is transmitted out not through the color filter units 14.

The embodiments of the present disclosure provide a display panel comprising a plurality of pixel units arranged in a matrix, and each of the pixel units comprises a first sub-pixel, a second sub-pixel and a third sub-pixel arranged in an arrangement direction, the first sub-pixels of ones, adjacent to one another in the arrangement direction of the sub-pixels, of the plurality of pixel units are adjacent to one another, and no black matrix is disposed at a corresponding position between the adjacent first sub-pixels.

Since each of the pixel units comprises the first sub-pixel, the second sub-pixel, and the third sub-pixel, and the first sub-pixels of the adjacent pixel units are adjacent to one another, two sub-pixels respectively located in two adjacent pixel units and having the same color can adjoin each other. Since there is no color crosstalk between two sub-pixels adjoining each other and having the same color, no black matrix may be disposed at a corresponding position between the two sub-pixels adjoining each other and having the same color. In this way, an area of a light-transmissible portion of the display panel and thus an area of an effective display region of the display panel can be increased, thereby raising an aperture ratio of the display panel.

Furthermore, generally the pixel unit 101 according to the embodiments of the present disclosure is constituted by three sub-pixels 10, for example, a red sub-pixel (R), a green sub-pixel (G) and a blue sub-pixel (B), as shown in FIG. 2.

In addition, as an example, in one pixel unit 101, the first sub-pixel 1011 is a blue sub-pixel (B), the second sub-pixel 1012 is a green sub-pixel (G), and the third sub-pixel 1013 is a red sub-pixel (R). The green sub-pixel (G) has a best light transmittance and is brightest, the red sub-pixel (R) has a lower light transmittance than the green sub-pixel (G), and the blue sub-pixel (B) has a relatively minimal light transmittance and is relatively dark. Therefore, if two adjacent sub-pixels 10 having the same color are green sub-pixels (G), positions corresponding to the green sub-pixels (G) are brighter, so that the pixel units 101 of the display panel 100 have a non-uniform display luminance.

Therefore, according to an example of the present disclosure, the first sub-pixel 1011 is a blue sub-pixel (B). In this way, two adjacent first sub-pixels 1011 having the same color can be blue sub-pixels (B), so that a luminance of a pixel region corresponding to the two adjacent blue sub-pixels (B) is increased. Thereby the pixel units 101 of the display panel 100 have a more uniform display luminance to improve a display effect.

Of course, in addition to use of the blue sub-pixels (B) having relatively dark brightness as all of the adjacent same first sub-pixels 1011, the adjacent third sub-pixels 1013 may be set to be the red sub-pixels (R), so that a luminance of a pixel region corresponding to the adjacent red sub-pixels (R) and a luminance of a pixel region corresponding to the two adjacent blue sub-pixels (B) can be increased. A uniformity of the luminance of the pixel units 101 of the display panel 100 is further improved, thereby improving the display effect.

It is to be noted herein that when the pixel unit 101 comprises a red sub-pixel (R), a green sub-pixel (G), a blue sub-pixel (B) and a white sub-pixel (W), the adjacent first sub-pixels 1011 having the same color may be the blue sub-pixels (B) and/or the adjacent third sub-pixels 1011 having the same color may be the red sub-pixels (R).

In addition, when the pixel unit 101 comprises a cyan sub-pixel, a magenta sub-pixel and a yellow sub-pixel, they may be set according to light transmittances of these sub-pixels by referring to the arrangement of the red sub-pixels (R), the green sub-pixels (G) and the blue sub-pixels (B), and are no longer described herein for the sake of brevity.

In addition, as shown in FIG. 3 (a section view taken along the direction O-O′ in FIG. 2), the display panel 100 comprises a black matrix 11 and an array substrate assembly 201 comprising a plurality of data lines Dn. The black matrix 11 is disposed at a position corresponding to the data lines Dn.

The data lines Dn have a certain light blocking effect. In order to further improve a light transmittance of the display panel 100, in an example of the present disclosure, the data lines Dn are not disposed at the corresponding position between the two adjacent same sub-pixels 10, so that no black matrix 11 is disposed between the two adjacent pixel units 101.

Specifically, the data line Dn for each of the two adjacent sub-pixels 10 of the adjacent pixel units 101 and 101′ is disposed at a corresponding position between the each sub-pixel 10 of the corresponding pixel unit 101 or 101′ and another sub-pixel 10 adjacent to the each sub-pixel 10.

The solution in which the data lines Dn are not disposed between the two adjacent same sub-pixels 10 will be described in detail as below. The following embodiments are all described by an example in which the first sub-pixel 1011 is a blue sub-pixel (B), the second sub-pixel 1012 is a green sub-pixel (G), and the third sub-pixel 1013 is a red sub-pixel (R).

For example, as shown in FIG. 5, the data lines Dn are not disposed between the two adjacent red sub-pixels (R), and the data lines Dn are not disposed between the two adjacent blue sub-pixels (B). In this case, the two adjacent pixel units (101 and 101′) are taken as an example. For the pixel unit 101′, two data lines (for example D1 and D2) may be disposed between the red sub-pixel (R) and the green sub-pixel (G), and one data line (for example D3) may be disposed between the green sub-pixel (G) and the blue sub-pixel (B). In addition, for the pixel unit 101, two data lines (for example D4 and D5) may be disposed between the blue sub-pixel (B) and the green sub-pixel (G), and one data line (for example D6) may be disposed between the green sub-pixel (G) and the red sub-pixel (R).

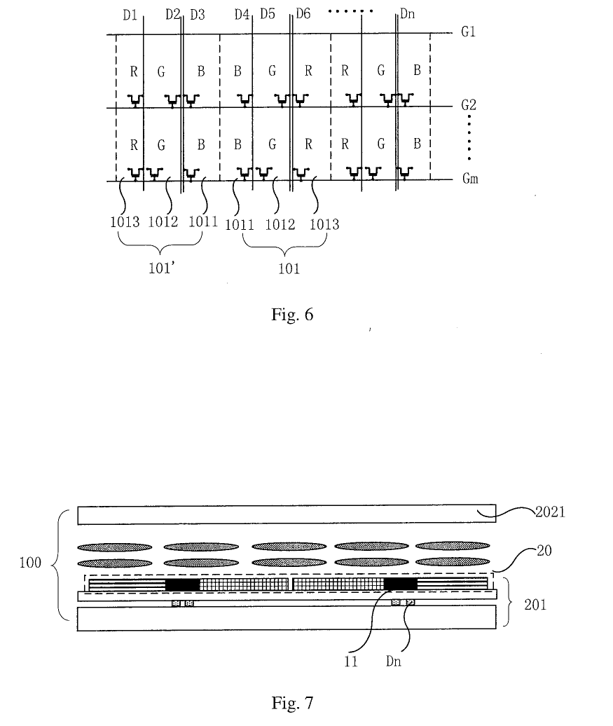

In addition, for example, as shown in FIG. 6, the data lines Dn are not disposed between the two adjacent red sub-pixels (R), and the data lines Dn are not disposed between the two adjacent blue sub-pixels (B). The example shown in FIG. 6 is different from that shown in FIG. 5 in the following aspects. For the pixel unit 101′, one data line (for example D1) may be disposed between the red sub-pixel (R) and the green sub-pixel (G), and two data lines (for example D2 and D3) may be disposed between the green sub-pixel (G) and the blue sub-pixel (B). In addition, for the pixel unit 101, one data line (for example D4) may be disposed between the blue sub-pixel (B) and the green sub-pixel (G), and two data lines (for example D5 and D6) may be disposed between the green sub-pixel (G) and the red sub-pixel (R).

Of course, the foregoing is only an exemplary illustration of the arrangement of the data lines Dn, and other arrangements of the data lines are no longer described herein for the sake of brevity so long as it can be ensured that the data lines Dn are not disposed between the two adjacent same sub-pixels 10.

In addition, the black matrix 11 is disposed at a position corresponding to the data lines Dn in the following manners. As shown in FIG. 3, when the display panel 100 is formed by assembling a color filter substrate assembly 202 and the array substrate assembly 201, the black matrix 11 may be disposed in the color filter substrate assembly 202 and correspond in position to the data lines Dn in order to shade positions where the data lines Dn are located.

Or, as shown in FIG. 7, when the array substrate assembly 201 is manufactured by means of a color-filter-on-array (COA) technique, the display panel 100 is formed by assembling the COA type array substrate assembly 201, in which the color filter layer 20 and the black matrix 11 are integrated, and a counterpart substrate assembly 2021. In this case, the black matrix 11 may be disposed in a position of the COA type array substrate assembly 201 above the corresponding data lines Dn.

In addition, it is also to be noted that even if the color filter areas of the sub-pixels 10 are increased, there should be a certain spacing C between the pixel electrodes 13 of the two adjacent same sub-pixels 10 as shown in FIG. 3, so that the two adjacent same sub-pixels 10 can be controlled independently. Arrangements of a pixel electrode 13 and a common electrode 16 of a sub-pixel 10 in different types of display panels 100 will be described in detail as below.

For example, when the display panel 100 is a twist nematic (TN) type display panel, the display panel 100 formed by assembling the color filter substrate assembly 202 and the array substrate assembly 201 shown in FIG. 3 is taken as an example. The pixel electrodes 13 and the common electrode 16 are located in the different substrate assemblies, the planar pixel electrode 13 is disposed in each sub-pixel 10 in the array substrate assembly 201, and the planar common electrode 16 is located in the color filter substrate assembly 202.

According to embodiments of the present disclosure, a spacing C between the planar pixel electrodes 13 of the two adjacent same sub-pixels 10 is in the range of 4.5 μm-5.5 μm. Specifically, when the spacing C is greater than 5.5 μm, a spacing between the sub-pixels is excessively large to decrease areas of the sub-pixels themselves, thereby reducing a display effect. When the spacing C is less than 4.5 μm, requirements on a manufacturing process are relatively high so that production cost is increased.

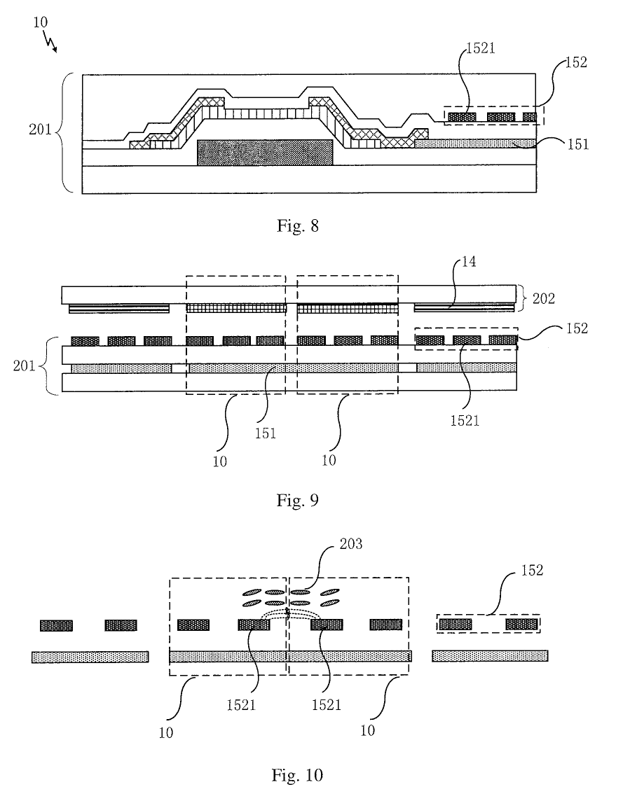

In addition, for example, as shown in FIG. 8, when the display panel 100 is an advanced super dimensional switching (ADS) type display panel, a first electrode 151 of planar shape and a second electrode 152 that is composed of a plurality of strip-shaped sub-electrodes 1521 are disposed in each sub-pixel 10 in the array substrate assembly 201 of the ADS display panel. FIG. 8 illustrates only an example in which the first electrode 151 is the pixel electrode and the second electrode 152 is the common electrode.

Of course, the first electrode 151 may also be the common electrode while the second electrode 152 is the pixel electrode. In this case, a spacing C between the planar pixel electrodes (i.e. the second electrodes 152) of the two adjacent same sub-pixels 10 may be in the range of 4.5 μm-5.5 μm. In this way, when the spacing C is greater than 5.5 μm, a spacing between the sub-pixels is excessively large to decrease areas of the sub-pixels themselves, thereby reducing a display effect. When the spacing C is less than 4.5 μm, requirements on a manufacturing process are relatively high so that production cost is increased.

In addition, as shown in FIG. 9, when the first electrode 151 is the common electrode while the second electrode 152 is the pixel electrode, the common electrodes (i.e. the first electrodes 151) of the two adjacent same sub-pixels 10 may be disposed in an integrated structure. In this way, when the two adjacent common electrodes are disposed in an integrated structure, a resistance of the common electrodes and thus a load of the display panel can be decreased, thereby reducing power consumption of the display panel.

As will be noted, the ADS type display panel has the first electrode 151 and the second electrode 152 that is composed of the plurality of strip-shaped sub-electrodes 1521, and the second electrode 152 is disposed in a different layer from that where the first electrode 151 is located. Therefore, as shown in FIG. 10, a direction of an electric field between two adjacent ones of the plurality of strip-shaped sub-electrodes 1521 is approximately a horizontal direction, and arrangement directions of liquid crystal molecules 203 in this position are also approximately the horizontal direction under the action of the horizontal electric field. When the liquid crystal molecules 203 are arranged in the horizontal direction, backlight under the liquid crystal molecules 203 cannot pass through them. As a result, light cannot be transmitted between the two adjacent strip-shaped sub-electrodes 1521. In this case, when the second electrode 152 composed of the plurality of strip-shaped sub-electrodes 1521 is the pixel electrode, an electric field between the two adjacent same sub-pixels 10 and the electric field between the two adjacent strip-shaped electrodes have the same function. Therefore, light cannot be transmitted between the two adjacent same sub-pixels 10. As a result, even if the black matrix 11 at the corresponding position between the two adjacent same sub-pixels 10 is directly removed, a contrast of a picture displayed by the display panel 100 will not be adversely affected too much.

Embodiments of the present disclosure further provide a display apparatus comprising the abovementioned display panel 100, and the display apparatus has the same configuration and advantageous effects as the display panel 100 according to the above embodiments. The configuration and advantageous effects of the display panel 100 have been described in the above embodiments in detail and thus are no longer described for the sake of brevity.

It is to be noted that in the embodiments of the present disclosure, the display apparatus may comprise a liquid crystal display panel. For example, the display panel may be applied to any products or parts having displaying function, such as a liquid crystal display, a liquid crystal TV, a digital frame, a mobile telephone or a tablet computer.

Embodiments of the present disclosure also provide a method of manufacturing a display panel, and the method comprises: forming, on a substrate, a plurality of pixel units 101 arranged in a matrix, wherein each of the plurality of pixel units 101 comprises a first sub-pixel 1011, a second sub-pixel 1012 and a third sub-pixel 1013 arranged in an arrangement direction, and in the arrangement direction of the sub-pixels 10, an arrangement sequence of the sub-pixels 10 of one of two adjacent pixel units 101 is opposite to an arrangement sequence of the sub-pixels 10 of the other of the two adjacent pixel units 101, and no black matrix 11 is disposed between the two adjacent pixel units 101.

The method is a specific method of manufacturing the abovementioned display panel 100, and has the same advantageous effects as the display panel 100 according to the above embodiments. The advantageous effects of the display panel 100 have been described in the above embodiments in detail and thus are no longer described for the sake of brevity.

The above contents are only the specific embodiments of the present disclosure. However, the protection scope of the present disclosure is not limited thereto. Changes or substitutions that can be easily conceived by any person skilled in the art within the technical scope disclosed in the present disclosure should be contained within the protection scope of the present disclosure. Therefore, the protection scope of the present disclosure should be defined by the protection scope of the claims.

1. A display panel comprising:
a plurality of pixel units arranged in a matrix, and each comprising a first sub-pixel, a second sub-pixel and a third sub-pixel arranged in an arrangement direction,
wherein the first sub-pixels of ones, adjacent to one another in the arrangement direction, of the pixel units are adjacent to one another, and no black matrix is disposed at a corresponding position between the adjacent first sub-pixels.

2. The display panel of claim 1, wherein:
the third sub-pixels of ones, adjacent to one another in the arrangement direction, of the pixel units are adjacent to one another, and no black matrix is disposed at a corresponding position between the adjacent third sub-pixels.

3. The display panel of claim 1, further comprising:
a black matrix, and an array substrate assembly,
wherein the array substrate assembly comprises a plurality of data lines, and the black matrix is disposed at a position corresponding to the data lines, and
wherein the data lines are not disposed at the corresponding position between the adjacent first sub-pixels.

4. The display panel of claim 1, further comprising:
a black matrix, and an array substrate assembly,
wherein the array substrate assembly comprises a plurality of data lines, and the black matrix is disposed at a position corresponding to the data lines, and
wherein the data line for each of the adjacent first sub-pixels of the adjacent pixel units is disposed at a corresponding position between the each first sub-pixel of the corresponding pixel unit and another sub-pixel adjacent to the each first sub-pixel.

5. The display panel of claim 1, wherein:
the first sub-pixel is a blue sub-pixel, the second sub-pixel is a green sub-pixel, and the third sub-pixel is a red sub-pixel.

6. The display panel of claim 1, further comprising:
a color filter layer comprising color filter units,
wherein the color filter units of the adjacent first sub-pixels are disposed in an integrated structure.

7. The display panel of claim 1, further comprising:
a color filter layer comprising color filter units; and
a transparent region located between the color filter units of the adjacent first sub-pixels and connected directly to the color filter units of the adjacent first sub-pixels.

8. The display panel of claim 3, further comprising:
a first electrode of a planar shape and a second electrode composed of a plurality of strip-shaped sub-electrodes, wherein the first electrode and the second electrode are disposed in each sub-pixel in the array substrate assembly.

9. The display panel of claim 8, wherein:
the first electrode is a common electrode, and the second electrode is a pixel electrode, and
the common electrodes of the adjacent first sub-pixels are disposed in an integrated structure.

10. The display panel of claim 8, wherein:
the first electrode is a pixel electrode, and the second electrode is a common electrode.

11. The display panel of claim 1, wherein:
a spacing between the pixel electrodes of the adjacent first sub-pixels is in the range of 4.5 μm-5.5 μm.

12. A display apparatus comprising:
the display panel according to claim 1.

13. A method of manufacturing a display panel, comprising:
forming, on a substrate, a plurality of pixel units arranged in a matrix,
wherein each of the pixel units comprises a first sub-pixel, a second sub-pixel and a third sub-pixel arranged in an arrangement direction, the first sub-pixels of ones, adjacent to one another in the arrangement direction, of the plurality of pixel units are adjacent to one another, and no black matrix is disposed at a corresponding position between the adjacent first sub-pixels.

14. The display panel of claim 2, wherein:
the first sub-pixel is a blue sub-pixel, the second sub-pixel is a green sub-pixel, and the third sub-pixel is a red sub-pixel.

15. The display panel of claim 10, wherein:
a spacing between the pixel electrodes of the adjacent first sub-pixels is in the range of 4.5 μm-5.5 μm.
